(19) United States
(12) Patent Application Publication
(10) Pub. No.: US 2018/0189868 A1
(43) Pub. Date: Jul. 5, 2018

(54) METHOD AND SYSTEM FOR FACILITATING PURCHASE OF VEHICLES BASED ON BIDDING

(71) Applicant: Ruben Guinovart, Miami, FL (US)

(72) Inventor: Ruben Guinovart, Miami, FL (US)

(21) Appl. No.: 15/859,137

(22) Filed: Dec. 29, 2017

Related U.S. Application Data
(60) Provisional application No. 62/439,962, filed on Dec. 29, 2016.

(51) Int. Cl. G06Q 30/08; G06Q 30/02; G06F 15/18

(52) U.S. Cl. CPC G06Q 30/08; G06F 15/18; G06Q 30/0282

(57) ABSTRACT

Disclosed is a method of facilitating purchase of vehicles based on. The method may include receiving one or more criteria corresponding to a vehicle from a buyer device associated with a buyer. Further, the method may include identifying multiple dealers based on the one or more criteria. Yet further, the method may include transmitting the one or more criteria to the multiple dealer devices associated with the multiple dealers. Moreover, the method may include receiving multiple bids from the multiple dealer devices. Further, the method may include transmitting the multiple bids to the buyer device associated with the buyer. Yet further, the method may include receiving a selection of a bid of the multiple bids from the buyer device. Moreover, the method may include transmitting a notification to a dealer device associated with the bid based on the selection.

### FIELD OF THE INVENTION

The present invention relates to vehicle sales. In particular, the present invention relates to purchasing vehicles based on bidding.

### BACKGROUND OF THE INVENTION

Typically, buyers may visit multiple vehicle dealers to select a vehicle for purchase. However, the buyers may find it difficult to receive the best deal in their area. Further, the vehicle dealers are dependent on the buyers that may visit them. This may limit their sales.

Moreover, automotive referrals are not crowdsourced currently. However, sometimes the general public may know of better deals, which vehicle dealers themselves are not aware of.

Accordingly, there is a need for improved methods and systems for facilitating the purchase of vehicles that may overcome one or more of the abovementioned problems and/or limitations.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

Disclosed is a method of facilitating purchase of vehicles based on bidding. The method may include receiving, using a communication device, one or more criteria corresponding to a vehicle from a buyer device associated with a buyer. Further, the method may include identifying, using a processing device, multiple dealers based on the one or more criteria. Further, the method may include transmitting, using the communication device, the one or more criteria to the multiple dealer devices associated with the multiple dealers. Further, the method may include receiving, using the communication device, multiple bids from the multiple dealer devices. Further, the method may include transmitting, using the communication device, the multiple bids to the buyer device associated with the buyer. Further, the buyer device may be configured for presenting the multiple bids to the buyer. Further, the method may include receiving, using the communication device, a selection of a bid of the multiple bids from the buyer device. Further, the buyer device may be configured for receiving an input representing the selection from the buyer. Further, the method may include transmitting, using the communication device, a notification to a dealer device associated with the bid based on the selection.

According to some aspects, a system for facilitating purchase of vehicles based on bidding is disclosed. The system may include a communication device configured for receiving, using a communication device, one or more criteria corresponding to a vehicle from a buyer device associated with a buyer. Further, the communication device may be configured for transmitting the one or more criteria to multiple dealer devices associated with multiple dealers. Further, the communication device may be configured for receiving multiple bids from the multiple dealer devices. Further, the communication device may be configured for transmitting the multiple bids to the buyer device associated with the buyer. Further, the buyer device may be configured for presenting the multiple bids to the buyer. Further, the communication device may be configured for receiving a selection of a bid of the multiple bids from the buyer device. Further, the buyer device may be configured for receiving an input representing the selection from the buyer. Further, the communication device may be configured for transmitting a notification to a dealer device associated with the bid based on the selection. Further, the system may include a processing device configured for identifying the multiple dealers based on the one or more criteria.

According to some aspects, an automotive referral system is disclosed. The automotive referral system may utilize the members of the general public as sub-contractors. The members of the public may be utilized as sales people looking for vehicle deals. The automotive referral system may allow the members to reach local dealers. Further, the members may put in information and receive pertinent information back, based on the inputted specifications. Further, the members may access multiple dealers simultaneously. Accordingly, the automotive referral system enables crowdsourcing of automotive deals.

According to further aspects, the disclosed automotive referral system may include one or more of a process for paying a fee for providing a lead, a user portal process, a dealer process, a payment notification process, a process for sending business cards, a dealer bidding process, a process where the buyer can view the deal, a preference selection process, and a public referral process.

According to further aspects, a software application for buyers is provided. The software application may provide a one-stop shop for the buyers. The buyers may receive the best price on a vehicle, as well as financing through the dealer or third party, and an insurance quote. Moreover, a marketplace is also provided. The marketplace may allow buyers to purchase vehicles from other members or receive trade-in offers from dealers. Further, financing and insurance quote options may be provided to buyers in both a Bids section and a Marketplace section of the software application. The dealers will benefit from data collected by the software application throughout a buyer's journey through the application. Further, the software application may make the leads available for a fee to be determined at a later date. The dealer who wins a bid may be able to contact the seller and complete the deal in person, using data sent through the software application to process the transaction as effortlessly as possible. Moreover, the software application may also offer dealers competitive analysis on real deals, enabling them to remain competitive. Further, an Application Programming Interface (API) may be provided to make inventory management within the software application as simple as possible, reducing steps for maintenance so salespeople can focus on the consumer.

The present disclosure benefits buyers, as it makes the vehicle buying easier, reduces hassle, allows buyers to buy either from the computer at home or work, and the buyers are guaranteed the best deal. Further, the present disclosure also benefits dealers, as it provides leads, error tracking, tracking of needs, and other analytics to the dealers.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of a platform consistent with various embodiments of the present disclosure.

FIG. 2 is a block diagram of a system for facilitating the purchase of vehicles based on bidding in accordance with some embodiments.

FIG. 3 illustrates a flowchart of a method for facilitating the purchase of vehicles based on bidding, in accordance with some embodiments.

FIG. 4 illustrates a flowchart of a method for obtaining a bid recommendation model, in accordance with some embodiments.

FIG. 5 illustrates a flowchart of a method for obtaining a recommended bid, in accordance with some embodiments.

FIG. 6 illustrates a flowchart of a method for providing multiple dealer ratings associated with the multiple dealers, in accordance with some embodiments.

FIG. 7 illustrates a flowchart of a method for ranking the multiple bids, in accordance with some embodiments.

FIG. 8 illustrates a flowchart of a method for obtaining buyer ratings, in accordance with some embodiments.

FIG. 9 illustrates a flowchart of a method for producing buyer ratings, in accordance with some embodiments.

FIG. 10 illustrates a flowchart of a method for receiving leads, in accordance with some exemplary embodiments.

FIG. 11 illustrates a flowchart of a method for receiving bids, in accordance with some exemplary embodiments.

FIG. 12 illustrates a flowchart of a method for receiving payments, in accordance with some exemplary embodiments.

FIG. 13 illustrates a flowchart of a method for sending business cards, in accordance with some exemplary embodiments.

FIG. 14 illustrates a flowchart of a method for obtaining buyers requirements, in accordance with some exemplary embodiments.

FIG. 15 illustrates an exemplary computing system that may be employed to implement processing functionality for various embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.” The following detailed description refers to the accompanying drawings.

Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of vehicle sales, embodiments of the present disclosure are not limited to use only in this context.

### Overview

According to some aspects, the present disclosure provides a web and mobile platform which makes it easier for vehicle buyers to get the best price deals on a vehicle by connecting them with qualified dealers. The web and mobile platform may be named “AutosBest”. The dealers may put up their best bids on the web and mobile platform and the vehicle buyers may simply choose a bid. The buyers may then contact the dealer to finalize the transaction. The bidding process enables efficient transactions as it avoids haggling and long waits for approval. Buyers may also apply for financing through a third party or directly through dealer.

The dealers get the advantage of having approved buyers go directly to them. The buyers may be given a predetermined time period (such as 48 hours) to purchase a bid. If a buyer does not purchase a bid within the predetermined time period, dealers get access to the buyer's information as a lead. All buyers may also be screened to verify their qualification. Therefore, the disclosed web and mobile platform is a win for both sides as the buyers spend less time in the showroom and get a great deal while the dealers gain more traction and buyers.

According to further aspects, a multiplatform application is disclosed for the vehicle buyers and the dealers. For example, the buyers may have access to a web application, an iOS application, and an Android application. Further, the dealers may have access to a web-based application (dashboard) to process bids, receive consumer data, and observe competition. Moreover, administrators may access a web application to monitor and support buyers, dealers, and their transactions.

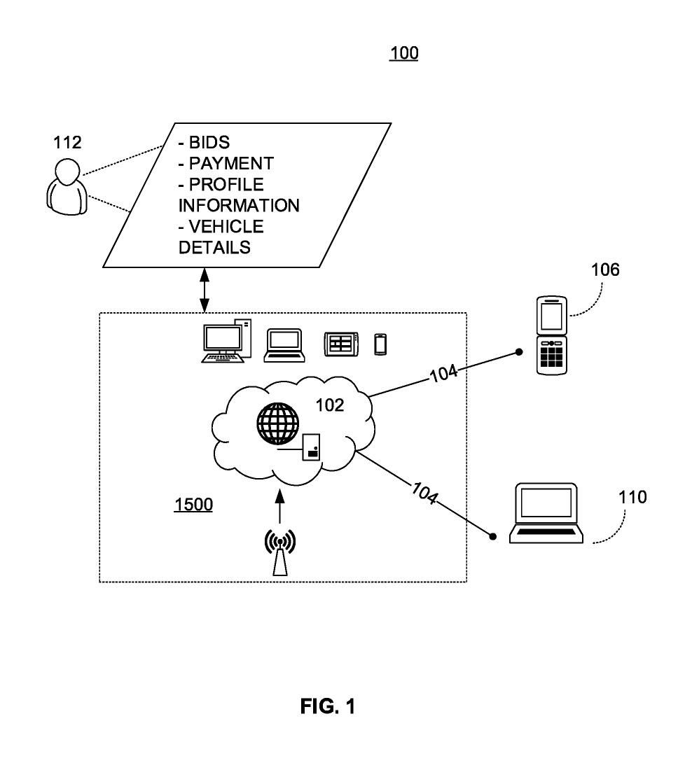

Referring now to figures, FIG. 1 is an illustration of a platform 100 consistent with various embodiments of the present disclosure. By way of non-limiting example, the online platform 100 for facilitating purchase of vehicles based on bidding may be hosted on a centralized server 102, such as, for example, a cloud computing service. The centralized server 102 may communicate with other network entities, such as, for example mobile devices 106 (such as a smartphone, a laptop, a tablet computer etc.), and/or other electronic devices 110 (such as desktop computers, etc.), over a communication network 104, such as, but not limited to, the Internet. Further, users of the platform 100 may include one or more relevant parties such as buyers, dealers, and system administrators. Accordingly, electronic devices operated by the one or more relevant parties may be in communication with the platform 100.

A user 112, such as the one or more relevant parties, may access platform 100 through a software application. The software application may be embodied as, for example, but not be limited to, a website, a web application, a desktop application, and a mobile application compatible with a computing device 1500.

Additionally, the online platform may maintain a database comprising a plurality of inventories corresponding to a plurality of dealers. The plurality of inventories may include information regarding new and/or used vehicles available for purchase (e.g. rent, lease, or sale). Further, the online platform may maintain a master inventory comprising each of the plurality of inventories. Further, in some instances, the master inventor may further comprise information regarding new and/or used vehicles available for purchase from individuals. Accordingly, in an instance, when a first dealer of the plurality of dealers wins a bid for selling a desired vehicle but does not currently have the desired vehicle in a first inventory corresponding to the first dealer, the online platform may facilitate the first dealer to procure the desired vehicle from a second dealer of the plurality of dealers and subsequently provision the desired vehicle to the buyer. Accordingly, the online platform may query the master inventory in order to identify one or more other dealers who currently have the desired vehicle.

Further, in some embodiments, the online platform may be configured to facilitate populating the plurality of inventories and/or the inventories corresponding to a plurality of individuals (i.e. independent sellers). Accordingly, the online platform may provision an app configured to execute on a mobile device operated by one or more of the buyer, the one or more dealers and one or more individuals. Further, the app may be configured to receive image data from a camera comprised in the mobile device. For example, the image data may correspond to a picture of a license plate of a vehicle, a driver's license, an insurance document and so on. Further, the app may be configured to analyze the image data in order to automatically extract one or more relevant data such as personal details about the buyer, the plurality of dealers and the one or more individuals. Further, the app may be configured to perform optical character recognition (OCR) on the image data to extract information such as, but not limited to, license plate number, driver's license number etc. Accordingly, the app may be configured to communicate with an external database and/or the online platform to retrieve further relevant data based on the extracted one or more relevant data. For example, the app may be configured to communicate with an online service such as Carfax in order to retrieve detailed information regarding the vehicle based on a picture of the vehicle and/or the license plate of the vehicle. Further, the app may be configured to upload one or more of the image data, the extracted one or more relevant data and the further relevant data to the online platform. Additionally, in some embodiments, the online platform may facilitate one or more of extraction of the one or more relevant data and retrieval of the further relevant data. Further, the online platform may also be configured to provision such data generated in cooperation with the app to other entities such as insurance companies, banks etc. Accordingly, the need for manually providing such relevant data in order to facilitate purchase of vehicles may be eliminated.

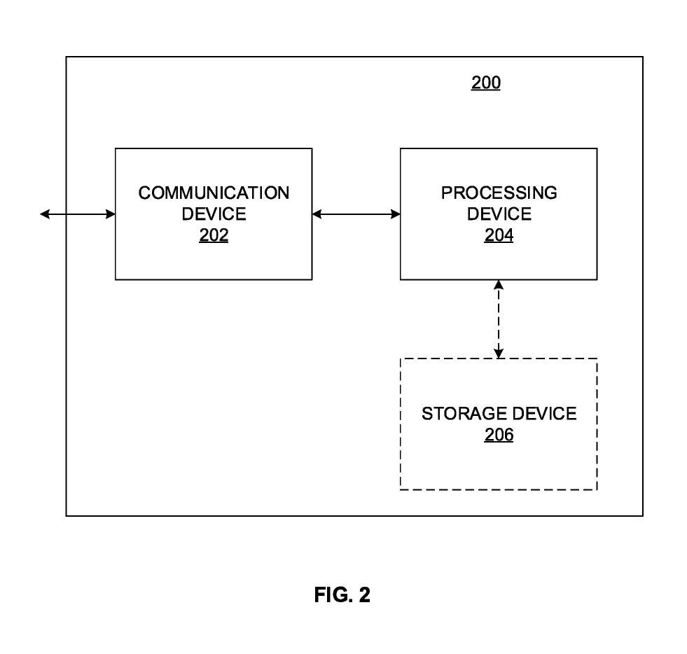

FIG. 2 is a block diagram of a system 200 for facilitating purchase of vehicles based on bidding in accordance with some embodiments. The system 200 may include a communication device 202 and a processing device 204. The communication device 202 may be configured for receiving, using a communication device 202, one or more criteria corresponding to a vehicle from a buyer device associated with a buyer. For example, the one or more criteria may include, but is not limited to, manufacturer, model, price, model year, vehicle type, distance traveled, mileage, roof height, leg space, maintenance, road clearance, steering functionality, brakes, lighting and luggage space.

Further, the processing device 204 may be configured for identifying multiple dealers based on the one or more criteria. Accordingly, the communication device 202 may be configured for transmitting the one or more criteria to multiple dealer devices associated with multiple dealers. Further, the communication device 202 may be configured for receiving multiple bids from the multiple dealer devices. Each bid in the multiple bids may include bid information, such as, but not limited to, a bid price, an insurance price, a fuel price, a price of optional features of the vehicle. The bid information may be used to customize orders and resolve disputes.

Further, the communication device 202 may be configured for transmitting the multiple bids to the buyer device associated with the buyer. Further, the buyer device may be configured for presenting the multiple bids to the buyer. Yet further, the communication device 202 may be configured for receiving a selection of a bid of the multiple bids from the buyer device. Further, the buyer device may be configured for receiving an input representing the selection from the buyer. Further, the communication device 202 may be configured for transmitting a notification to a dealer device associated with the bid based on the selection.

Accordingly, in some embodiments, further to receiving the notification, the dealer may initiate a transaction to fulfill the purchase of the vehicle. In an instance, the online platform may provide a communication interface, such as for example, instant messaging, voice call, video call, etc. over one or more communication networks such as, but not limited to, cellular network, satellite network, Internet and so on. Accordingly, in an instance, the online platform may enable the dealer and the buyer to establish an electronic communication (e.g. email, SMS, IM, voice call, video call, virtual presence etc.). Further, the online platform may provide relevant documents to one or more of the buyer device and the dealer device in order to fulfill the transaction. For example, the relevant documents may include, service agreement, sale agreement, lease agreement, financing terms, KYC documents, etc. Accordingly, one or more of the buyer and the dealer may provide consent and/or electronic signatures on the relevant documents in order to finalize the transaction. Alternatively, the online platform may be configured to receive scan copies of signed documents from one or more of the buyer device and the dealer device. Further, the online platform may also be configured to direct the buyer to a payment gateway in order to facilitate receipt of payment towards the purchase.

In some embodiments, the communication device 202 may be further configured for transmitting the multiple bids to each of the multiple dealer devices. Further, each dealer device may be configured for presenting the multiple bids. Therefore, each of the multiple dealers may review the bids submitted by the other dealers in the multiple dealers. Thereafter, one or more dealers in the multiple dealers may update their own bids based on the bids submitted by the other dealers. Accordingly, the communication device 202 may be configured for receiving one or more updated bids from one or more dealer devices of the one or more dealers. Further, the multiple bids transmitted to the buyer device may include the one or more updated bids.

In some embodiments, the system 200 may further include a storage device 206 configured for storing bidding session data including each of the one or more criteria, the multiple bids, the selection, a buyer profile associated with the buyer and multiple dealer profiles associated with the multiple dealers. For example, a buyer profile may include information such as, but not limited to, name, address, contact details, credit score, buyer rating, purchase history, and payment details. For example, a dealer profile may include information such as, but not limited to, name, address, contact details, dealer rating, credit score, and past sales. Further, the processing device 204 may be configured for performing machine learning over the bidding session data and generating a bid recommendation model based on the machine learning. The machine learning may increase the chances of acceptance of bids by the buyers.

Further, the communication device 202 may be configured for receiving a recommendation request from a dealer device of the multiple dealer devices. The processing device 204 may be further configured for generating a recommended bid based on the bid recommendation model in response to the recommendation request. The communication device 202 may be configured for transmitting the recommended bid to the dealer device.

In some embodiments, the communication device 202 may be further configured for receiving transaction data from one or more of the buyer device and the dealer device. The transaction data may correspond to purchasing of the vehicle by the buyer from the dealer. Therefore, the bidding session data further may include the transaction data.

In some embodiments, the storage device 206 may be configured for retrieving multiple dealer ratings associated with the multiple dealers. A dealer rating in the multiple dealer ratings may be provided by buyers for the previous bids/deals made by a corresponding dealer. Further, the communication device 202 may be configured for transmitting the multiple dealer ratings to the buyer device.

In some embodiments, the communication device 202 may be further configured for receiving at least one buyer feedback corresponding to one or more dealers of the multiple dealers from the buyer device. For example, a buyer feedback in the at least one buyer feedback may be provided by a buyer by filling an online form. Further, the processing device 204 may be configured for generating one or more dealer ratings corresponding to the one or more dealers based on the at least one buyer feedback. The multiple dealer ratings may include the one or more dealer ratings. Further, the storage device 206 configured for storing the one or more dealer ratings in association with one or more dealer identifiers of the one or more dealers.

In further embodiments, the processing device 204 may be configured for generating multiple ranks associated with the multiple bids based on the multiple dealer ratings and the multiple bids. For example, a rank (in the multiple ranks) associated with a bid may indicate the chance of acceptance of the bid. Further, the buyer device may be configured for presenting the multiple bids based on the multiple ranks.

In some embodiments, the storage device 206 may be configured for retrieving a buyer rating associated with the buyer. Further, the communication device 202 may be configured for transmitting the buyer rating to the multiple dealer devices.

In further embodiments, the communication device 202 may be configured for receiving at least one dealer feedback corresponding to the buyer from one or more dealer devices. For example, a dealer feedback in the at least one dealer feedback may be provided by a dealer by filling an online form. Further, the processing device 204 may be configured for generating the buyer rating based on the at least one dealer feedback. Further, the storage device 206 configured for storing the buyer rating in association with a buyer identifier of the buyer.

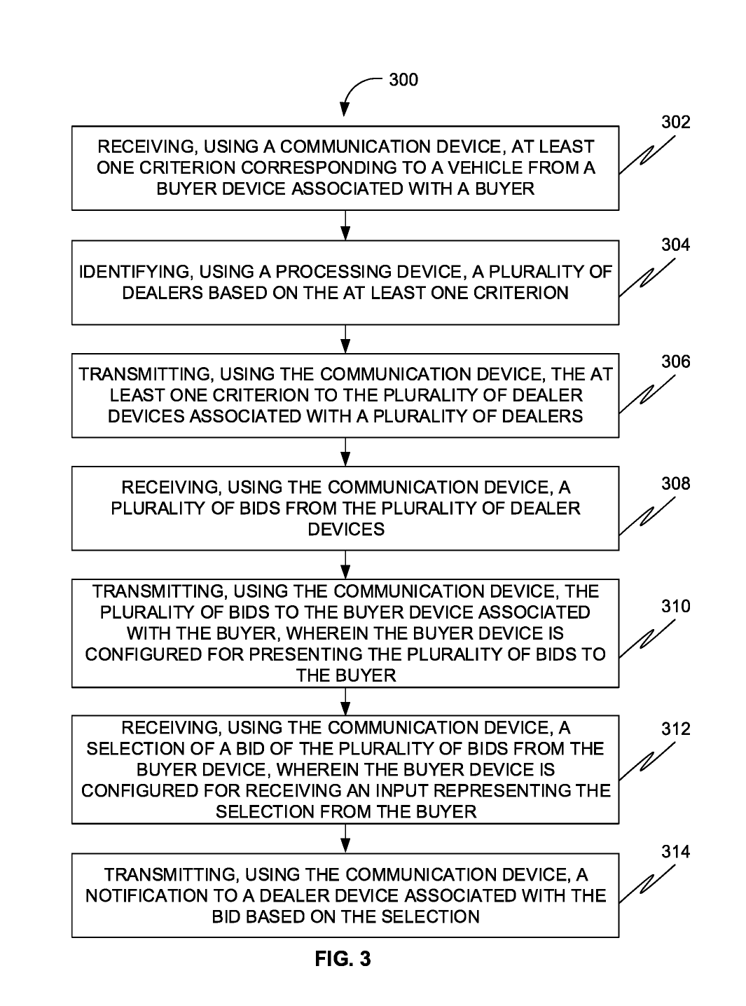

FIG. 3 illustrates a flowchart of a method 300 for facilitating purchase of vehicles based on bidding, in accordance with some embodiments. At 302, the method 300 may include receiving, using a communication device (such as the communication device 202), one or more criteria corresponding to a vehicle from a buyer device associated with a buyer. For example, the one or more criteria may include, but is not limited to, manufacturer, model, price, model year, vehicle type, distance traveled, mileage, roof height, leg space, maintenance, road clearance, steering functionality, brakes, lighting and luggage space.

Further, at 304, the method 300 may include identifying, using a processing device (such as the processing device 204), multiple dealers based on the one or more criteria. Further, at 306, the method 300 may include transmitting, using the communication device, the one or more criteria to the multiple dealer devices associated with the multiple dealers. Further, at 308, the method 300 may include receiving, using the communication device, multiple bids from the multiple dealer devices. Further, at 310, the method 300 may include transmitting, using the communication device, the multiple bids to the buyer device associated with the buyer. Further, the buyer device may be configured for presenting the multiple bids to the buyer. Each bid in the multiple bids may include bid information, such as, but not limited to, a bid price, an insurance price, a fuel price, a price of optional features of the vehicle. The bid information may be used to customize orders and resolve disputes.

Further, at 312, the method 300 may include receiving, using the communication device, a selection of a bid of the multiple bids from the buyer device. Further, the buyer device may be configured for receiving an input representing the selection from the buyer. Further, at 314, the method 300 may include transmitting, using the communication device, a notification to a dealer device associated with the bid based on the selection.

In further embodiments, the method 300 may include transmitting, using the communication device, the multiple bids to each of the multiple dealer devices. Each dealer device may be configured for presenting the multiple bids. Therefore, each of the multiple dealers may review the bids submitted by the other dealers in the multiple dealers. Thereafter, one or more dealers in the multiple dealers may update their own bids based on the bids submitted by the other dealers. Further, the method 300 may include receiving, using the communication device, one or more updated bids from one or more dealer devices of the multiple dealer devices. The multiple bids transmitted to the buyer device may include the one or more updated bids.

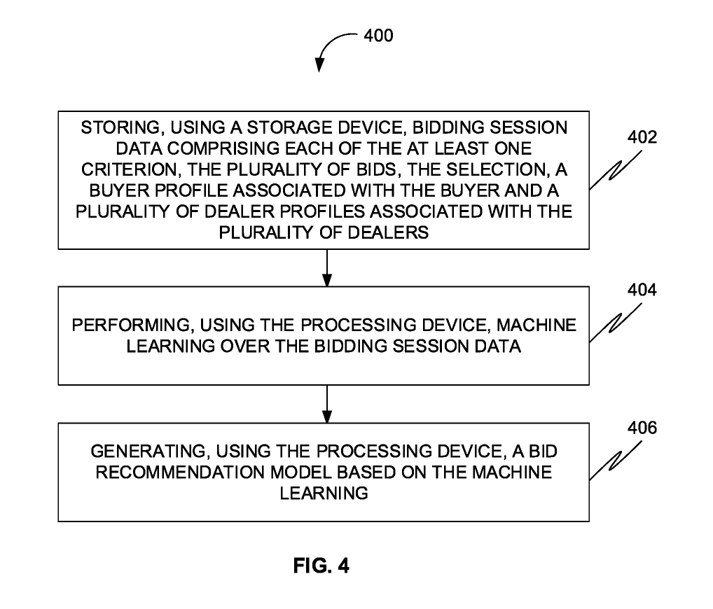

FIG. 4 illustrates a flowchart of a method 400 for obtaining a bid recommendation model, in accordance with some embodiments. At 402, the method 400 may include storing, using a storage device (such as the storage device 206), bidding session data. The bidding session data may include each of the one or more criteria, the multiple bids, the selection, a buyer profile associated with the buyer and multiple dealer profiles associated with the multiple dealers. At 404, the method 400 may include performing, using the processing device, machine learning over the bidding session data. At 406, the method 400 may include generating, using the processing device, the bid recommendation model based on the machine learning.

In further embodiments, the method 400 may include receiving, using the communication device, transaction data from one or more of the buyer device and the dealer device. The transaction data may correspond to purchasing of the vehicle by the buyer from the dealer. Accordingly, the bidding session data further may include the transaction data.

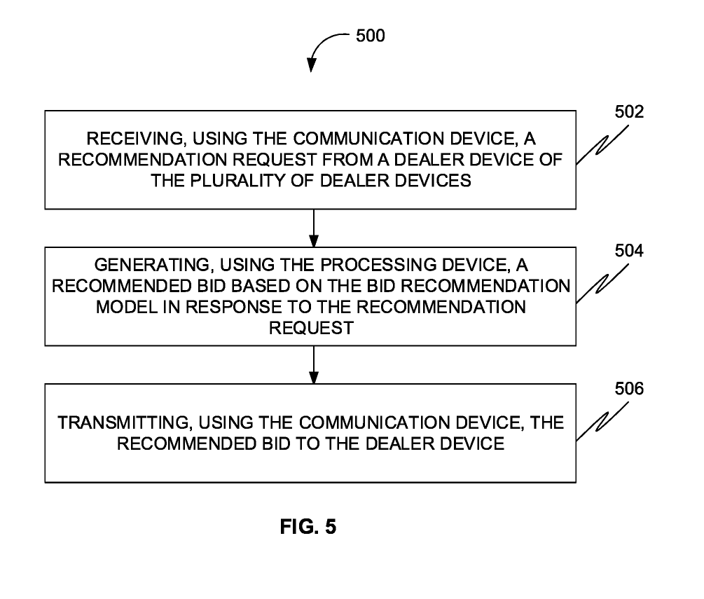

FIG. 5 illustrates a flowchart of a method 500 for obtaining a recommended bid, in accordance with some embodiments. At 502, the method 500 may include receiving, using the communication device, a recommendation request from a dealer device of the multiple dealer devices. At 504, the method 500 may include generating, using the processing device, the recommended bid based on the bid recommendation model in response to the recommendation request. At 506, the method 500 may include transmitting, using the communication device, the recommended bid to the dealer device.

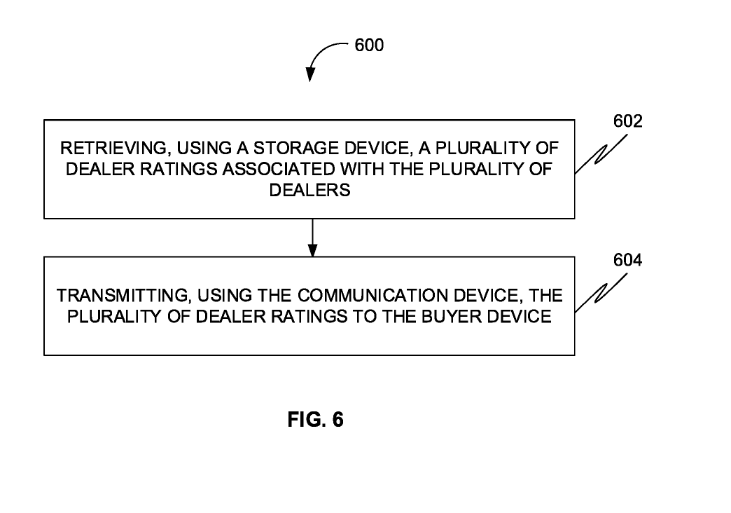

FIG. 6 illustrates a flowchart of a method 600 for providing multiple dealer ratings associated with the multiple dealers, in accordance with some embodiments. A dealer rating in the multiple dealer ratings may be provided by buyers for the previous bids/deals made by a corresponding dealer. At 602, the method 600 may include retrieving, using the storage device, the multiple dealer ratings. At 604, the method 600 may include transmitting, using the communication device, the multiple dealer ratings to the buyer device.

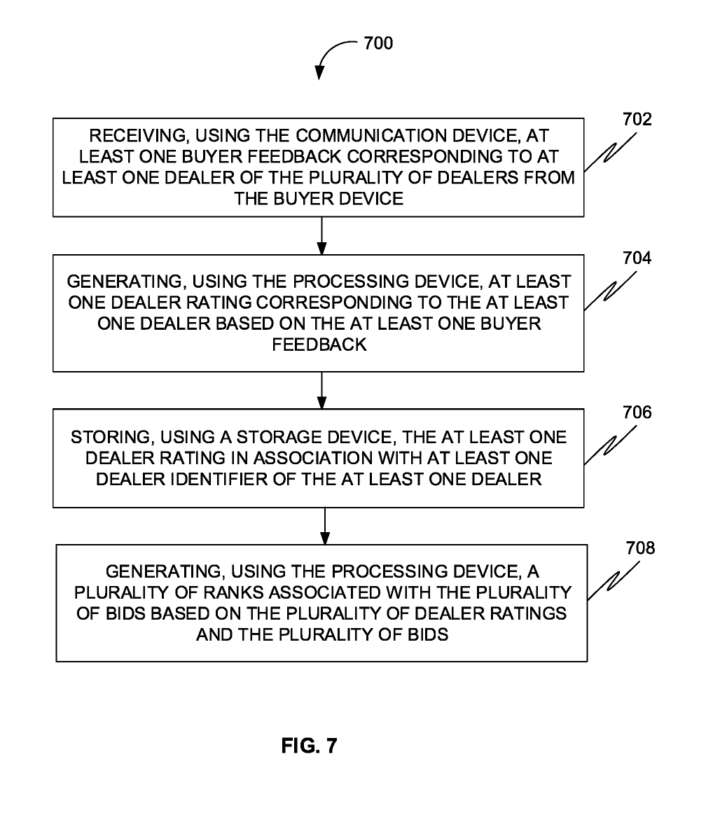

FIG. 7 illustrates a flowchart of a method 700 for ranking the multiple bids, in accordance with some embodiments. At 702, the method 700 may include receiving, using the communication device, at least one buyer feedback corresponding to one or more dealers of the multiple dealers from the buyer device. For example, a buyer feedback in the at least one buyer feedback may be provided by a buyer by filling an online form.

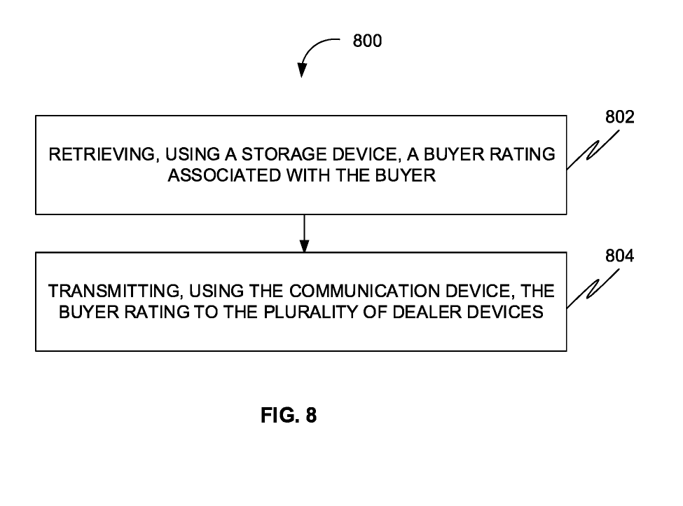

Further, at 704, the method 700 may include generating, using the processing device, one or more dealer ratings corresponding to the one or more dealers based on the at least one buyer feedback. The multiple dealer ratings may include the one or more dealer ratings. At 706, the method 700 may include storing, using a storage device, the one or more dealer ratings in association with one or more dealer identifiers of the one or more dealers. At 708, the method 700 may include generating, using the processing device, multiple ranks associated with the multiple bids based on the multiple dealer ratings and the multiple bids. For example, a rank (in the multiple ranks) associated with a bid may indicate the chance of acceptance of the bid. Further, the buyer device may be configured for presenting the multiple bids based on the multiple ranks FIG. 8 illustrates a flowchart of a method 800 for obtaining buyer ratings, in accordance with some embodiments. At 802, the method 800 may include retrieving, using a storage device, a buyer rating associated with the buyer. At 804, the method 800 may include transmitting, using the communication device, the buyer rating to the multiple dealer devices.

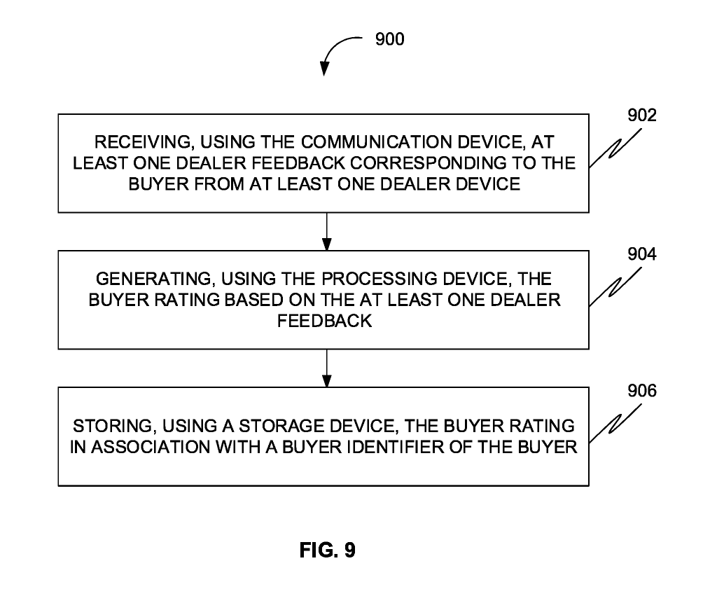

FIG. 9 illustrates a flowchart of a method 900 for producing buyer ratings, in accordance with some embodiments. At 902, the method 900 may include receiving, using the communication device, at least one dealer feedback corresponding to the buyer from one or more dealer devices. For example, a dealer feedback in the at least one dealer feedback may be provided by a dealer by filling an online form. At 904, the method 900 may include generating, using the processing device, the buyer rating based on the at least one dealer feedback. At 906, the method 900 may include storing, using a storage device, the buyer rating in association with a buyer identifier of the buyer.

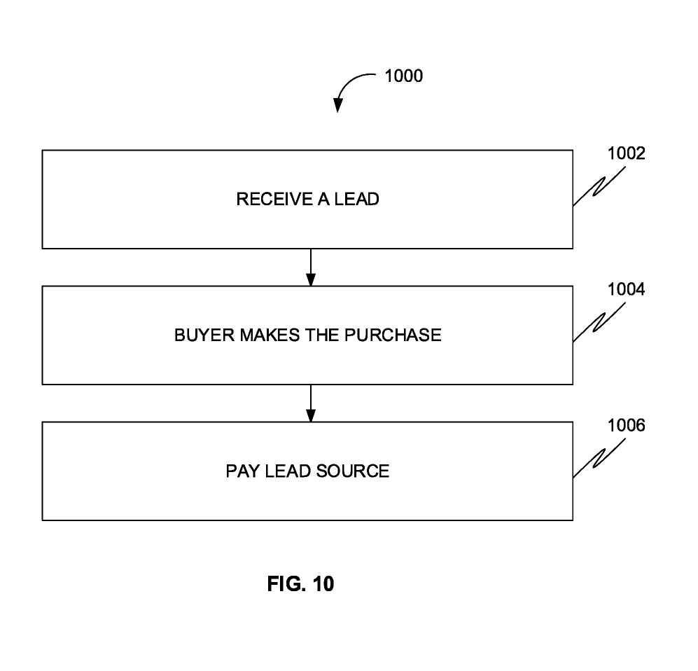

FIG. 10 illustrates a flowchart of a method 1000 for receiving leads, in accordance with some exemplary embodiments. At 1002, the method 1000 includes receiving a lead from a lead source, such as a contractor. Multiple buyers may view the lead. Then, at 1004, the method 1000 includes a buyer making the purchase based on the lead. Thereafter, at 1006, the method 1000 includes making payment to the lead source. For example, the lead source may be paid a fixed feed (such as $200) to send the lead. Alternatively, the payment amount to the lead source may vary.

According to an exemplary embodiment, a portal or software application is provided for one or more dealers. The dealers may be required to make payment to access the portal or the software application. For example, the dealers may be required to pay an average of $1000-3000 a month to access the portal or the software application. The portal or the software application provides leads to the dealers. Further, a portal or software application is provided for one or more buyers. This gives the dealers an opportunity to reach out to the buyers.

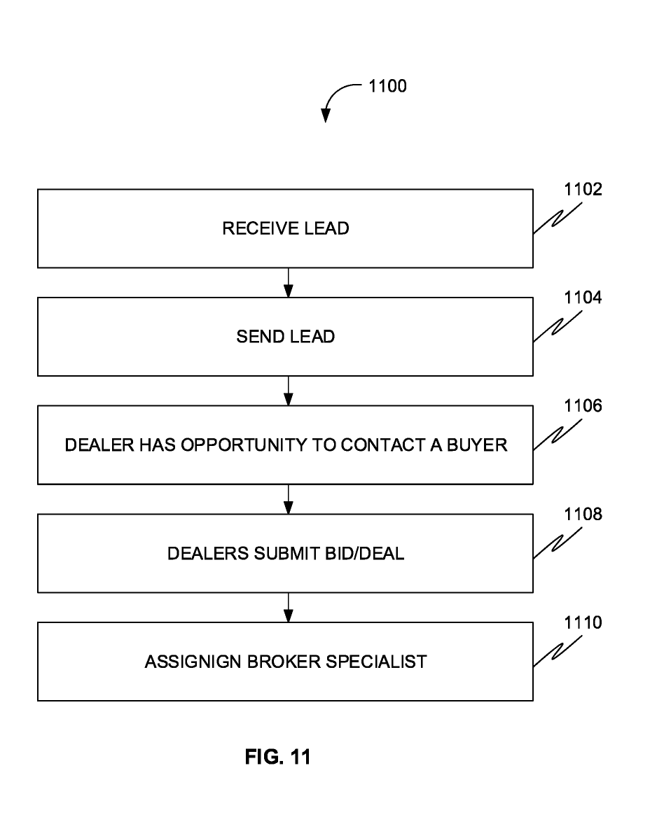

FIG. 11 illustrates a flowchart of a method 1100 for receiving bids, in accordance with some exemplary embodiments. At 1102, the method 1100 may include receiving a lead. Then, at 1104, the method 1100 may include sending the lead to one or more dealers. All dealers in the same area receive the same leads. Thereafter, at 1106, the one or more dealers have an opportunity to contact the corresponding buyers. Accordingly, the one or more dealers may submit a bid/deal on a vehicle chosen by a buyer at 1108. Further, at 1110, the method 1100 may include assigning a broker specialist to the buyer to help the buyer in closing the deal.

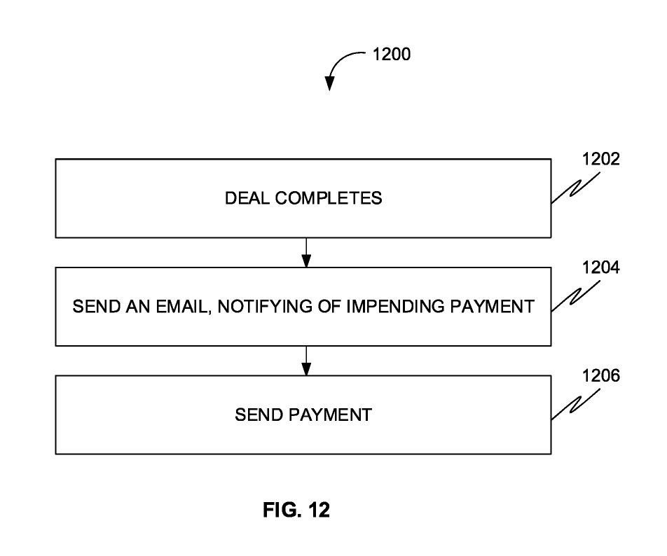

FIG. 12 illustrates a flowchart of a method 1200 for receiving payments, in accordance with some exemplary embodiments. At 1202, a deal completes. This may include receiving payment from the buyer.

Thereafter, at 1204, the method 1200 may include sending an email to the lead source, stating she will receive payment. At 1206, the method 1200 may include sending the payment to the lead source. For example, the lead source may be paid a fixed feed (such as $200) to send the lead. Alternatively, the payment amount to the lead source may vary.

Further, the dealer may be charged a fixed amount (such as $150) for receiving leads. Further, a fixed amount (say, $500) may be charged, if the buyers makes the purchase through the broker specialist. Alternatively, the dealer may be charged variable amounts.

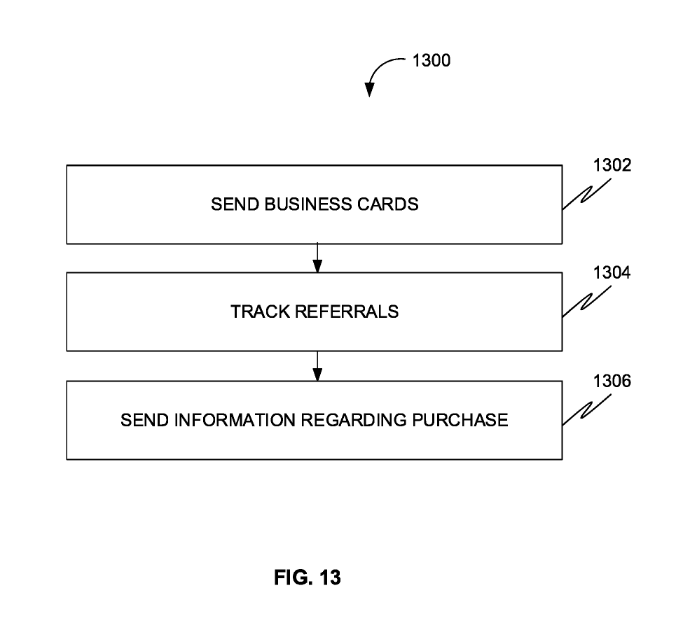

FIG. 13 illustrates a flowchart of a method 1300 for using business cards, in accordance with some exemplary embodiments. At 1302, the method 1300 may include sending the business cards to users, such as contractors. On the back of each business card, a unique code or SKU is provided. The unique code may be related to the identity of the corresponding contractor (such as name of the contractor) that referred the buyer. The unique codes are then used to track referrals from different contractors at 1304. Further, at 1306, the method 1300 may include automatically sending information to a contractor regarding whether a buyer has made the purchased or not.

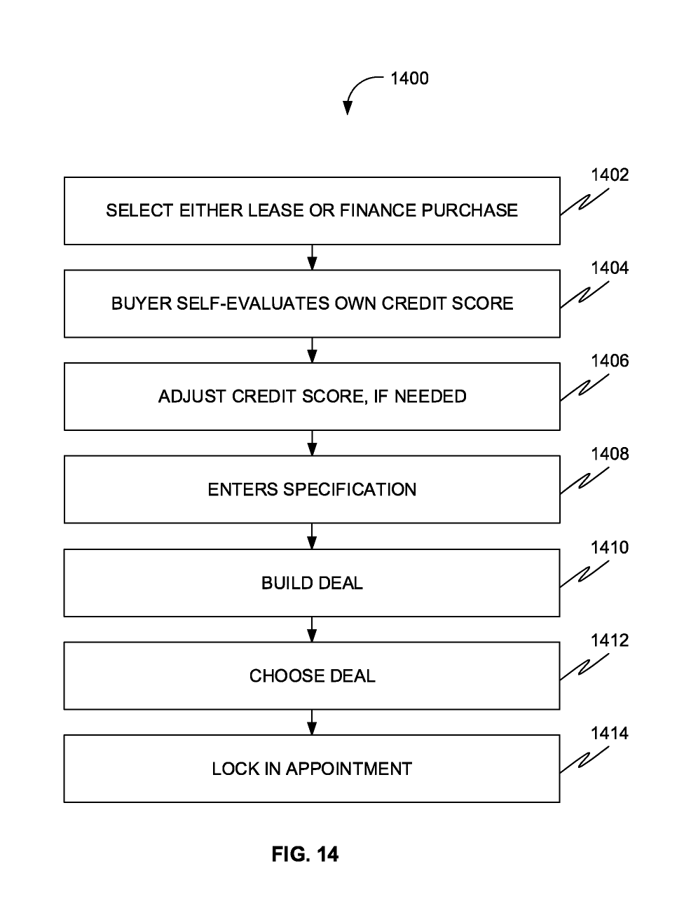

FIG. 14 illustrates a flowchart of a method 1400 for obtaining buyers requirements, in accordance with some exemplary embodiments. At 1402, the method 1400 may include a buyer setting up preferences by choosing a lease or finance purchase. At 1404, the method 1400 may include receiving a self-evaluated credit score from the buyer. For example, the buyer may select a number between 1-10 to represent her credit score. Thereafter, at 1406 the method 1400 may include adjusting the number (credit score) selected by the buyer based on a proprietary algorithm. Thereafter, the buyer may put in specifications at 1408. The specifications may include an amount of money, a term and a vehicle model. This gives the dealer an opportunity to build a deal at 1410. This gives a best deal to the buyer. Thereafter, the buyer may choose the deal at 1412 and lock in an appointment at 1414.

According to an exemplary embodiment, a dealer bidding process is disclosed. The dealer bidding process may give consumers the best deal as well by having dealers bid against one another for leads and deals without them knowing of other dealers' bids. Until the deal is concluded, they cannot be permitted to know which dealer gave the deal. However, the users may be able to view the deals pertaining to specific buyers once the transaction is complete. The dealers may have opportunities to call leads, up to the point buyers hit a ready button (provided on a user interface). If the dealer convinces a buyer to come in, then the dealer gets the deal. The dealer's bid on deals are sent to the buyers for purchase. Thereafter, the buyers may be required to hit the ready button to buy within a time period of twenty-hour hours. Alternatively, a different time period may be used.

Further, if buyers hit a “now” button (provided on a user interface), they may automatically receive a deal. The buyers may be guaranteed the “best” deal, which is the one presented to them. Further, an appointment may be set up for the buyer to go and actually purchase a vehicle.

Moreover, once the deal is signed, if there is a contractor involved in the process, she will receive an email stating she will receive a referral for that buyer. The dealers may track a buyer that did not buy and follow up. Further, the dealers may also track a deal they lost, and see how much they lost. The process (outlined above) eliminates a great deal of ambiguity from the situation as the buyers will know whether a deal is genuine or fraudulent.

According to an exemplary embodiment, a user interface for deal viewing may be provided to a buyer, such as in a mobile device of the buyer. The user interface may include one or more buttons, such as a ready button and a now button. The user interface may allow the buyer to see the best deals in selected areas. The deals may stand for twenty-four to forty-eight hours, typically due to inventory and rates programs. If a session runs past forty-eight hours, the buyers must redo the ready button. This will eliminate loss of leads due to passive sales staff, or mismanaged systems due to lack of supervision. The dealers must access their user interface to benefit off all leads.

According to an exemplary embodiment, a public referral process is disclosed. The public referral process allows crowdsourcing automotive deals from members of the public. The users (such as contractors) do not receive compensation unless a buyer signs up and purchases from a registered dealer. The referrals may be sent to the contractors.

Further, the buyers who sign-up must validate their email and/or phone number to log on. Such buyers must put in the code sent to them before they can send in a lead. Alternatively, the buyers must touch the ready button. This validation process helps eliminate false leads.

Further, the buyers may choose which manufacturer they want leads from. For example, Ford, Honda, Toyota, and so on. The buyer may also specify the range of the dealer they wish to drive out to, for example, a 20-mile radius or 50-mile radius, etc. Further, a buyer may be charged a sign-up fee (for example, $99). This fee may be refundable once the buyer goes to the dealer.

Further, preventive measures may be put in place to protect deposits. Further, a dealer deducts an extra $100 at time of buying. However, the deduction amount may vary.

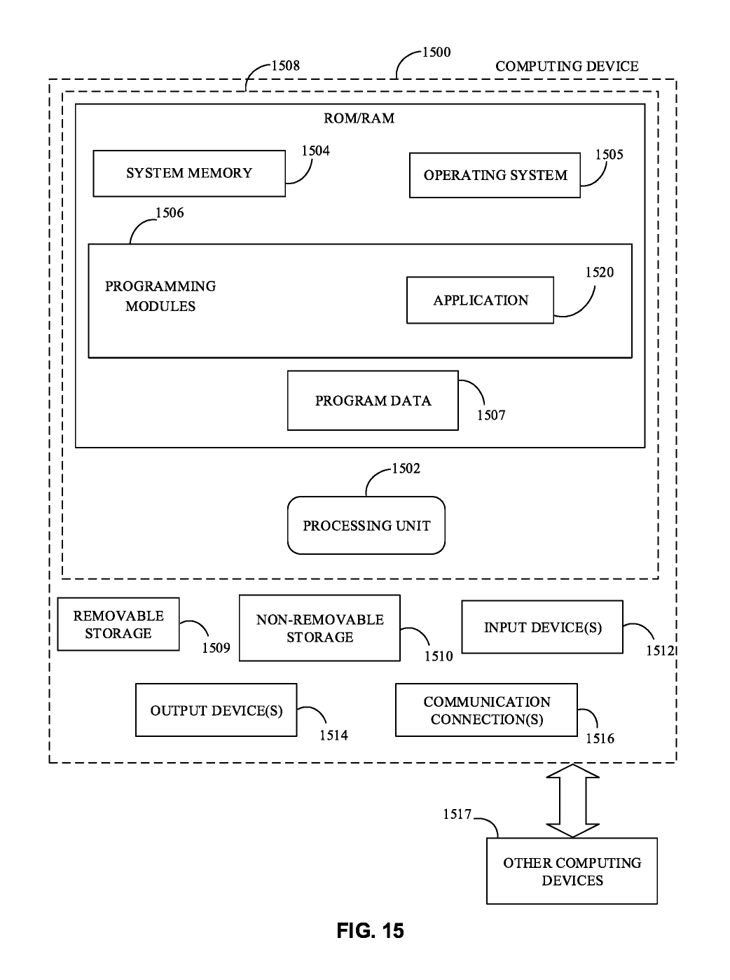

FIG. 15 is a block diagram of a system including computing device 1500. Consistent with an embodiment of the disclosure, the aforementioned memory storage and processing unit may be implemented in a computing device, such as computing device 1500 of FIG. 15. Any suitable combination of hardware, software, or firmware may be used to implement the memory storage and processing unit. For example, the memory storage and processing unit may be implemented with computing device 1500 or any of other computing devices 1518, in combination with computing device 1500. The aforementioned system, device, and processors are examples and other systems, devices, and processors may comprise the aforementioned memory storage and processing unit, consistent with embodiments of the disclosure.

With reference to FIG. 15, a system consistent with an embodiment of the disclosure may include a computing device or cloud service, such as computing device 1500. In a basic configuration, computing device 1500 may include at least one processing unit 1502 and a system memory 1504. Depending on the configuration and type of computing device, system memory 1504 may comprise, but is not limited to, volatile (e.g. random access memory (RAM)), non-volatile (e.g. read-only memory (ROM)), flash memory, or any combination. System memory 1504 may include operating system 1505, one or more programming modules 1506, and may include a program data 1507. Operating system 1505, for example, may be suitable for controlling computing device 1500's operation. In one embodiment, programming modules 1506 may include image encoding module, machine learning module and image classifying module. Furthermore, embodiments of the disclosure may be practiced in conjunction with a graphics library, other operating systems, or any other application program and is not limited to any particular application or system. This basic configuration is illustrated in FIG. 15 by those components within a dashed line 1508.

Computing device 1500 may have additional features or functionality. For example, computing device 1500 may also include additional data storage devices (removable and/or non-removable) such as, for example, magnetic disks, optical disks, or tape. Such additional storage is illustrated in FIG. 15 by a removable storage 1509 and a non-removable storage 1510. Computer storage media may include volatile and nonvolatile, removable and non-removable media implemented in any method or technology for storage of information, such as computer-readable instructions, data structures, program modules, or other data. System memory 1504, removable storage 1509, and non-removable storage 1510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1500. Any such computer storage media may be part of device 1500. Computing device 1500 may also have input device(s) 1512 such as a keyboard, a mouse, a pen, a sound input device, a touch input device, etc. Output device(s) 1514 such as a display, speakers, a printer, etc. may also be included. The aforementioned devices are examples and others may be used.

Computing device 1500 may also contain a communication connection 1516 that may allow device 1500 to communicate with other computing devices 1518, such as over a network in a distributed computing environment, for example, an intranet or the Internet. Communication connection 1516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1504, including operating system 1505. While executing on processing unit 1502, programming modules 1506 (e.g., application 1520) may perform processes including, for example, one or more stages of methods 300, 400 500, 600, 700, 800, 900, 1000, 1100, 1200, 1300 and 1400 as described above. The aforementioned process is an example, and processing unit 1502 may perform other processes.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may, in fact, be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

I/We claim:

1. A method of facilitating purchase of vehicles based on bidding, the method comprising:
receiving, using a communication device, at least one criterion corresponding to a vehicle from a buyer device associated with a buyer;
identifying, using a processing device, a plurality of dealers based on the at least one criterion;
transmitting, using the communication device, the at least one criterion to the plurality of dealer devices associated with the plurality of dealers;
receiving, using the communication device, a plurality of bids from the plurality of dealer devices;
transmitting, using the communication device, the plurality of bids to the buyer device associated with the buyer, wherein the buyer device is configured for presenting the plurality of bids to the buyer;
receiving, using the communication device, a selection of a bid of the plurality of bids from the buyer device, wherein the buyer device is configured for receiving an input representing the selection from the buyer; and
transmitting, using the communication device, a notification to a dealer device associated with the bid based on the selection.

2. The method of claim 1 further comprising:
transmitting, using the communication device, the plurality of bids to each of the plurality of dealer devices, wherein each dealer device is configured for presenting the plurality of bids; and
receiving, using the communication device, at least one updated bid from at least one dealer device of the plurality of dealer devices, wherein the plurality of bids transmitted to the buyer device comprises the at least one updated bid.

3. The method of claim 1 further comprising:
storing, using a storage device, bidding session data comprising each of the at least one criterion, the plurality of bids, the selection, a buyer profile associated with the buyer and a plurality of dealer profiles associated with the plurality of dealers;
performing, using the processing device, machine learning over the bidding session data; and
generating, using the processing device, a bid recommendation model based on the machine learning.

4. The method of claim 3 further comprising:
receiving, using the communication device, a recommendation request from a dealer device of the plurality of dealer devices;
generating, using the processing device, a recommended bid based on the bid recommendation model in response to the recommendation request; and
transmitting, using the communication device, the recommended bid to the dealer device.

5. The method of claim 3 further comprising receiving, using the communication device, transaction data from at least one of the buyer device and the dealer device, wherein the transaction data corresponds to purchasing of the vehicle by the buyer from the dealer, wherein the bidding session data further comprises the transaction data.

6. The method of claim 1 further comprising:
retrieving, using a storage device, a plurality of dealer ratings associated with the plurality of dealers; and
transmitting, using the communication device, the plurality of dealer ratings to the buyer device.

7. The method of claim 6 further comprising:
receiving, using the communication device, at least one buyer feedback corresponding to at least one dealer of the plurality of dealers from the buyer device;
generating, using the processing device, at least one dealer rating corresponding to the at least one dealer based on the at least one buyer feedback, wherein the plurality of dealer ratings comprises the at least one dealer rating; and
storing, using a storage device, the at least one dealer rating in association with at least one dealer identifier of the at least one dealer.

8. The method of claim 6 further comprising generating, using the processing device, a plurality of ranks associated with the plurality of bids based on the plurality of dealer ratings and the plurality of bids, wherein the buyer device is configured for presenting the plurality of bids based on the plurality of ranks.

9. The method of claim 1 further comprising:
retrieving, using a storage device, a buyer rating associated with the buyer; and
transmitting, using the communication device, the buyer rating to the plurality of dealer devices.

10. The method of claim 9 further comprising:
receiving, using the communication device, at least one dealer feedback corresponding to the buyer from at least one dealer device;
generating, using the processing device, the buyer rating based on the at least one dealer feedback; and
storing, using a storage device, the buyer rating in association with a buyer identifier of the buyer.

11. A system for facilitating purchase of vehicles based on bidding, the system comprising:
a communication device configured for:
receiving, using a communication device, at least one criterion corresponding to a vehicle from a buyer device associated with a buyer;
transmitting the at least one criterion to a plurality of dealer devices associated with a plurality of dealers;
receiving a plurality of bids from the plurality of dealer devices;
transmitting the plurality of bids to the buyer device associated with the buyer, wherein the buyer device is configured for presenting the plurality of bids to the buyer;
receiving a selection of a bid of the plurality of bids from the buyer device, wherein the buyer device is configured for receiving an input representing the selection from the buyer;
transmitting a notification to a dealer device associated with the bid based on the selection; and
a processing device configured for identifying the plurality of dealers based on the at least one criterion.

12. The system of claim 11, wherein the communication device is further configured for:
transmitting the plurality of bids to each of the plurality of dealer devices, wherein each dealer device is configured for presenting the plurality of bids; and
receiving at least one updated bid from at least one dealer device of the plurality of dealer devices, wherein the plurality of bids transmitted to the buyer device comprises the at least one updated bid.

13. The system of claim 11 further comprises a storage device configured for storing bidding session data comprising each of the at least one criterion, the plurality of bids, the selection, a buyer profile associated with the buyer and a plurality of dealer profiles associated with the plurality of dealers, wherein the processing device is further configured for:
performing machine learning over the bidding session data; and
generating a bid recommendation model based on the machine learning.

14. The system of claim 13, wherein the communication device is further configured for:
receiving a recommendation request from a dealer device of the plurality of dealer devices; and
transmitting the recommended bid to the dealer device, wherein the processing device is further configured for generating a recommended bid based on the bid recommendation model in response to the recommendation request.

15. The system of claim 13, wherein the communication device is further configured for receiving transaction data from at least one of the buyer device and the dealer device, wherein the transaction data corresponds to purchasing of the vehicle by the buyer from the dealer, wherein the bidding session data further comprises the transaction data.

16. The system of claim 11 further comprising a storage device configured for retrieving a plurality of dealer ratings associated with the plurality of dealers, wherein the communication device is further configured for transmitting the plurality of dealer ratings to the buyer device.

17. The system of claim 16, wherein the communication device is further configured for receiving at least one buyer feedback corresponding to at least one dealer of the plurality of dealers from the buyer device, wherein the processing device is further configured for generating at least one dealer rating corresponding to the at least one dealer based on the at least one buyer feedback, wherein the plurality of dealer ratings comprises the at least one dealer rating, wherein the storage device configured for storing the at least one dealer rating in association with at least one dealer identifier of the at least one dealer.

18. The system of claim 16, wherein the processing device is further configured for generating a plurality of ranks associated with the plurality of bids based on the plurality of dealer ratings and the plurality of bids, wherein the buyer device is configured for presenting the plurality of bids based on the plurality of ranks.

19. The system of claim 11 further comprising a storage device configured for retrieving a buyer rating associated with the buyer, wherein the communication device is further configured for transmitting the buyer rating to the plurality of dealer devices.

20. The system of claim 19, wherein the communication device is further configured for receiving at least one dealer feedback corresponding to the buyer from at least one dealer device, wherein the processing device configured for generating the buyer rating based on the at least one dealer feedback, wherein the storage device configured for storing the buyer rating in association with a buyer identifier of the buyer.
